(19) United States
(12) Patent Application Publication
(10) Pub. No.: US 2025/0111798 A1
(43) Pub. Date: Apr. 3, 2025

(54) Method and System for Generating Learning Problems

(71) Applicant: MATA EDU, INC., Seoul (KR)

(72) Inventors: Tae Hyoung Oh, Seoul (KR); Du Seop Jung, Gyeonggi-do (KR)

(21) Appl. No.: 18/887,252

(22) Filed: Sep. 17, 2024

(30) Foreign Application Priority Data
Sep. 18, 2023 (KR) 10-2023-0124343

(51) Int. Cl. G09B 7/08; G06F 40/40

(52) U.S. Cl. CPC G09B 7/08; G06F 40/40

(57) ABSTRACT

A method for generating learning problems is provided. The method includes the steps of: acquiring a first learning problem; generating a first solution explanation with reference to the first learning problem using a first language model, and generating a second solution explanation with reference to the first learning problem using a second language model; and generating a second learning problem with reference to at least one of the first solution explanation and the second solution explanation.

### FIELD OF THE INVENTION

The present invention relates to a method and system for generating learning problems.

### BACKGROUND

With the advancement of technology in computer-related fields, attempts have been made to apply various computer-related technologies to education-related fields.

In order to enhance the learning effectiveness of a user (e.g., elementary school student, middle school student, or high school student), it may be necessary to generate learning problems related to a specific topic that the user wishes to learn or customized according to the user's learning level (e.g., the user's academic achievement).

According to traditional learning approaches, a user should solve a specific learning problem and then proceed to learn from a predetermined explanation for the learning problem. However, this results in the user learning from a one-size-fits-all explanation that does not take into account the user's learning level, which may reduce the efficiency of learning. Further, if the user wishes to solve other problems analogous to the specific learning problem, the user faces the inconvenience of having to personally search for analogous types of problems in a content being used by the user (e.g., a specific math workbook).

In this connection, the inventor(s) present a technique capable of providing solution explanations customized for a user by generating solution explanations for learning problems in consideration of various factors including the user's learning level, and a technique for assisting the user to learn learning problems analogous to a specific learning problem and enhance the user's learning effectiveness by generating other learning problems analogous to the specific learning problem respectively using two or more language models.

### SUMMARY OF THE INVENTION

One object of the present invention is to solve all the above-described problems in the prior art.

Another object of the invention is to acquire a first learning problem, generate a first solution explanation with reference to the first learning problem using a first language model, and generate a second solution explanation with reference to the first learning problem using a second language model, and generate a second learning problem with reference to at least one of the first solution explanation and the second solution explanation.

Yet another object of the invention is to generate an appropriate second learning problem by generating solution explanations respectively using different language models and generating the second learning problem.

Still another object of the invention is to generate a second learning problem customized according to a user's learning level (e.g., a learning problem related to a concept identical or analogous to that of a first learning problem).

The representative configurations of the invention to achieve the above objects are described below.

According to one aspect of the invention, there is provided a method comprising the steps of: acquiring a first learning problem; generating a first solution explanation with reference to the first learning problem using a first language model, and generating a second solution explanation with reference to the first learning problem using a second language model; and generating a second learning problem with reference to at least one of the first solution explanation and the second solution explanation.

According to another aspect of the invention, there is provided a system comprising: an information acquisition unit configured to acquire a first learning problem; a solution explanation generation unit configured to generate a first solution explanation with reference to the first learning problem using a first language model, and generate a second solution explanation with reference to the first learning problem using a second language model; and a learning problem generation unit configured to generate a second learning problem with reference to at least one of the first solution explanation and the second solution explanation.

In addition, there are further provided other methods and systems to implement the invention, as well as non-transitory computer-readable recording media having stored thereon computer programs for executing the methods.

According to the invention, it is possible to acquire a first learning problem, generate a first solution explanation with reference to the first learning problem using a first language model, and generate a second solution explanation with reference to the first learning problem using a second language model, and generate a second learning problem with reference to at least one of the first solution explanation and the second solution explanation.

According to the invention, it is possible to generate an appropriate second learning problem by generating solution explanations respectively using different language models and generating the second learning problem.

According to the invention, it is possible to generate a second learning problem customized according to a user's learning level (e.g., a learning problem related to a concept identical or analogous to that of a first learning problem).

### BRIEF DESCRIPTION OF THE DRAWINGS

FIG. 1 schematically shows the configuration of an entire system according to one embodiment of the invention.

FIG. 2 specifically shows the internal configuration of an information generation system according to one embodiment of the invention.

FIGS. 3A and 3B illustratively show a learning problem and a solution explanation according to one embodiment of the invention.

FIGS. 4A and 4B illustratively show a learning problem and a solution explanation according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

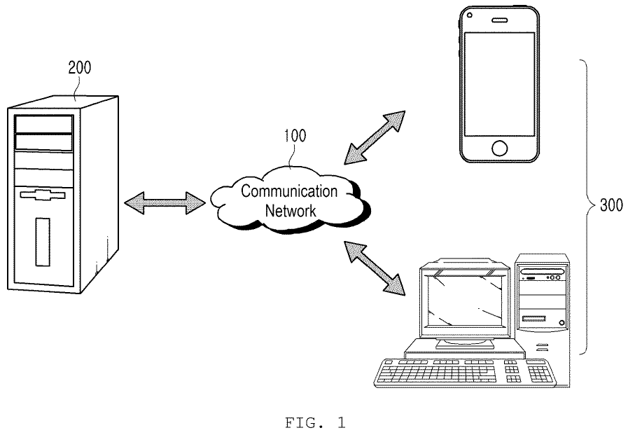

FIG. 1 schematically shows the configuration of the entire system according to one embodiment of the invention.

As shown in FIG. 1, the entire system according to one embodiment of the invention may comprise a communication network 100, an information generation system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the information generation system 200 according to one embodiment of the invention may function to: acquire a first learning problem, and acquire at least one of a clue associated with the first learning problem and a user's learning level; and generate a first solution explanation with reference to at least one of the clue associated with the first learning problem and the user's learning level using a first language model.

Further, the information generation system 200 according to one embodiment of the invention may function to: acquire a first learning problem; generate a first solution explanation with reference to the first learning problem using a first language model, and generate a second solution explanation with reference to the first learning problem using a second language model; and generate a second learning problem with reference to at least one of the first solution explanation and the second solution explanation.

The configuration and functions of the information generation system 200 according to the invention will be discussed in more detail below.

Next, the device 300 according to one embodiment of the invention is digital equipment capable of connecting to and then communicating with the information generation system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the information generation system 200. The application may be downloaded from the information generation system 200 or an external application distribution server (not shown). Meanwhile, the characteristics of the application may be generally similar to those of an information acquisition unit 210, a solution explanation generation unit 220, a concept extraction unit 230, a communication unit 250, and a control unit 260 of the information generation system 200 to be described below. Here, at least a part of the application may be replaced with a hardware device or a firmware device that may perform a substantially equal or equivalent function, as necessary.

### Configuration of the Information Generation System

Hereinafter, the internal configuration of the information generation system 200 crucial for implementing the invention and the functions of the respective components thereof will be discussed.

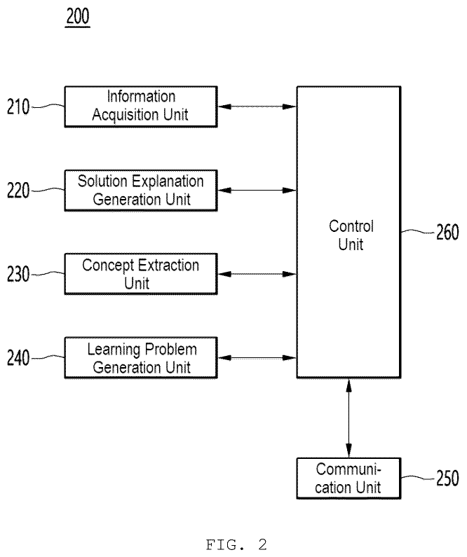

FIG. 2 specifically shows the internal configuration of the information generation system 200 according to one embodiment of the invention.

As shown in FIG. 2, the information generation system 200 according to one embodiment of the invention may comprise an information acquisition unit 210, a solution explanation generation unit 220, a concept extraction unit 230, a learning problem generation unit 240, a communication unit 250, and a control unit 260. According to one embodiment of the invention, at least some of the information acquisition unit 210, the solution explanation generation unit 220, the concept extraction unit 230, the learning problem generation unit 240, the communication unit 250, and the control unit 260 may be program modules to communicate with an external system (not shown). The program modules may be included in the information generation system 200 in the form of operating systems, application program modules, and other program modules, while they may be physically stored in a variety of commonly known storage devices. Further, the program modules may also be stored in a remote storage device that may communicate with the information generation system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the information generation system 200 has been described as above, and it will be apparent to those skilled in the art that at least a part of the components or functions of the information generation system 200 may be implemented in the device 300 or a server (not shown) or included in an external system (not shown), as necessary.

First, the information acquisition unit 210 according to one embodiment of the invention may function to acquire a first learning problem, and acquire at least one of a clue associated with the first learning problem and a user's learning level.

Specifically, the information acquisition unit 210 according to one embodiment of the invention may acquire a first learning problem.

For example, the first learning problem according to one embodiment of the invention may include a learning problem that may be acquired online or offline. For example, the first learning problem according to one embodiment of the invention may include a learning problem that may be acquired from at least one of a database associated with the information generation system 200 (e.g., a math problem database) and an external system (e.g., a web server). As another example, the first learning problem according to one embodiment of the invention may include a learning problem (e.g., math problem, English problem, Korean problem, or science problem) used for learning of a user (e. g., kindergartener, elementary school student, middle school student, or high school student). As another example, the first learning problem according to one embodiment of the invention may include a learning problem specified by an administrator among at least one learning problem.

Further, the information acquisition unit 210 according to one embodiment of the invention may acquire at least one of a clue associated with the first learning problem and a user's learning level.

For example, the clue associated with the first learning problem according to one embodiment of the invention may include at least one of context information of the first learning problem (e.g., information on a correct answer to the first learning problem), type information of the first learning problem (e.g., information on whether the first learning problem is a multiple-choice problem or a subjective problem), and unit information of the first learning problem (e.g., information on a unit in a curriculum to which the first learning problem belongs).

As another example, the user's learning level according to one embodiment of the invention may include a learning level of the user who is to use (or have already used) the first learning problem. Specifically, the user's learning level according to one embodiment of the invention may include at least one of the user's academic achievement and past learning history (e.g., correct answer rates recorded by the user when using past learning problems).

As another example, at least one of the clue associated with the first learning problem and the user's learning level according to one embodiment of the invention may be acquired from at least one of a database associated with the information generation system 200 (e.g., a database where student history information is stored, or a database related to student records) and an external system (e.g., the National Education Information System (NIES) of the Office of Education).

Meanwhile, the user (or administrator) may provide at least one of the first learning problem, the clue associated with the first learning problem, and the user's learning level according to one embodiment of the invention, which may be acquired by the information acquisition unit 210.

Next, the solution explanation generation unit 220 according to one embodiment of the invention may function to generate a first solution explanation with reference to at least one of the clue associated with the first learning problem and the user's learning level using a first language model.

Specifically, the first language model according to one embodiment of the invention may include a generative artificial intelligence model (e.g., ChatGPT, Codex, or Bard) that may generate responses (e.g., text, images, or videos) to at least one prompt (or input). The first language model according to one embodiment of the invention may also include a deep learning-based generative artificial intelligence model.

Further, the first solution explanation generated by the solution explanation generation unit 220 according to one embodiment of the invention may refer to a solution explanation corresponding to the first learning problem.

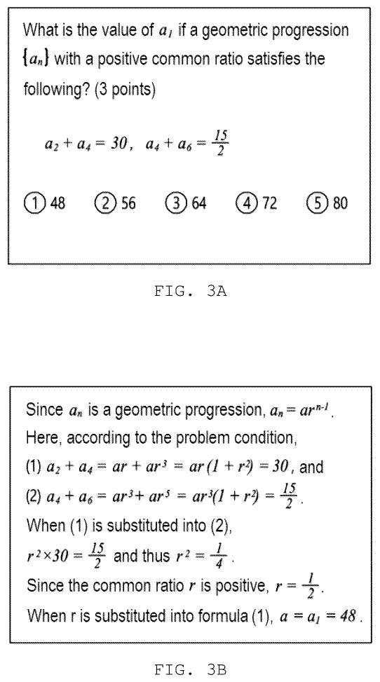

FIGS. 3A and 3B illustratively show a learning problem and a solution explanation according to one embodiment of the invention.

For example, referring to FIG. 3A, the first learning problem according to one embodiment of the invention may be a math problem related to a geometric progression. Further, referring to FIG. 3B, the first solution explanation according to one embodiment of the invention may be a solution explanation corresponding to the first learning problem.

Language models (e.g., generative artificial intelligence models) may generate inappropriate solution explanations even for simple learning problems when no context regarding the learning problems or solution explanations is provided (e.g., may generate a solution explanation for a math problem related to a middle school first-year curriculum using mathematical theories learned in a college math course, or generate a solution explanation for a problem related to a geometric progression using calculus theories).

Therefore, in a situation where the solution explanation generation unit 220 according to one embodiment of the invention generates the first solution explanation using the first language model, the first solution explanation may be generated with reference to at least one of the clue associated with the first learning problem (e.g., a clue indicating that the first learning problem is associated with a progression unit of a high school second-year first-semester math subject) and the user's learning level (e.g., past learning history indicating that the user's past problem-solving results show a correct answer rate of 50%, which is 15% lower compared to other students), so that the first solution explanation may be consistent with the context of the learning problem while being customized according to the user's learning level.

Further, the solution explanation generation unit 220 according to one embodiment of the invention may generate the first solution explanation to have a difficulty level higher than a predetermined difficulty level in response to the user's learning level being not lower than a predetermined learning level, and to have a difficulty level lower than the predetermined difficulty level in response to the user's learning level being lower than the predetermined learning level.

Academic levels of two or more users (e.g., students) may vary and solution explanations with difficulty levels customized according to the academic levels of the users may be generated according to the invention. However, the academic levels of the users may be greatly diverse so that if individual solution explanations are generated according to the academic levels of all the users, the accuracy of the generated solution explanations may not be guaranteed.

Therefore, the solution explanation generation unit 220 according to one embodiment of the invention may classify a learning level of a specific user (e.g., a learning level indicating that the user's academic achievement is higher or lower than the academic achievement of a group to which the user belongs) into one of two or more reference learning levels (e.g., a first reference learning level indicating that the academic achievement is determined to be high, a second reference learning level indicating that the academic achievement is determined to be low, and a third reference learning level indicating that the academic achievement is determined to be near average), and generate the first solution explanation with reference to the reference learning level corresponding to the user's learning level.

In other words, the solution explanation generation unit 220 according to one embodiment of the invention may classify diverse learning levels of two or more users into two or more reference learning levels, and generate the first solution explanation to have difficulty levels corresponding to the reference learning levels, such that the first solution explanation may correspond to diverse difficulty levels (e.g., the number of generated solution explanations may correspond to the number of reference learning levels) while being contextually consistent (or accurate).

However, it will be apparent to those skilled in the art that the method of generating the first solution explanation with reference to the user's learning level according to one embodiment of the invention is not limited to those described above, but may be diversely changed as long as the objects of the invention may be achieved.

Next, the concept extraction unit 230 according to one embodiment of the invention may function to extract at least one concept associated with at least one element included in the first solution explanation.

Specifically, the at least one element included in the first solution explanation according to one embodiment of the invention may include at least one of text elements, graphic elements, and formula elements included in the first solution explanation.

For example, referring to FIG. 3B, the at least one element included in the first solution explanation according to one embodiment of the invention may include text elements (e.g., “geometric progression”, “common ratio”, “positive”, and “formula”) and formula elements (e.g., the formula denoted as (1) shown in the third line, the formula denoted as (2) shown in the fourth line, and the formula shown in the sixth line) included in the first solution explanation. Here, the concept extraction unit 230 according to one embodiment of the invention may extract at least one concept (e.g., “calculating the first term of a geometric progression”) associated with the at least one element included in the first solution explanation.

Further, the concept extraction unit 230 according to one embodiment of the invention may determine information on the at least one extracted concept as a tag for the first learning problem.

For example, referring to FIG. 3B, the concept extraction unit 230 according to one embodiment of the invention may determine the at least one extracted concept (e.g., “calculating the first term of a geometric progression”) as a tag for the first learning problem.

In order to enhance the user's learning effect, it may be important for the user to repeatedly learn problems of types analogous to those of math problems corresponding to concepts in which the user is weak. In order to repeatedly learn the analogous problems, problems analogous to a specific problem should be provided to the user. If the concept extraction unit 230 according to one embodiment of the invention determines information on the at least one concept as a tag for the first learning problem, tags of many learning problems (e.g., thousands of learning problems) may be determined as in the above-described embodiment of the invention, and the user may use learning problems (e.g., five learning problems) corresponding to specific tags by searching for (or selecting) the specific tags, allowing the user to repeatedly learn concepts in which the user is weak.

Further, an association between at least one element and at least one concept according to one embodiment of the invention may be determined by an inference model for inferring associations between elements and concepts included in solution explanations.

Specifically, the inference model according to one embodiment of the invention may include a generative artificial intelligence model (e.g., ChatGPT, Codex, or Bard) that may generate responses (e.g., text, images, or videos) to at least one prompt (or input). Further, the inference model according to one embodiment of the invention may refer to a model derived by learning associations between two or more of a predetermined solution explanation, at least one predetermined element corresponding to the solution explanation, at least one predetermined concept corresponding to the at least one element, and a predetermined tag corresponding to the at least one predetermined concept. Further, the inference model according to one embodiment of the invention may be implemented as a model that is wholly or partially identical to the first language model.

For example, the inference model according to one embodiment of the invention may be derived by learning a relationship between at least one predetermined element (e.g., “geometric progression”, “common ratio”, “positive”, and “formula”) corresponding to a specific solution explanation and at least one predetermined concept (e.g., “calculating the first term of a geometric progression”) corresponding to the at least one predetermined element. Here, according to one embodiment of the invention, when the first learning problem (e.g., a learning problem related to calculating the first term of an arithmetic progression) is acquired and at least one of the clue associated with the first learning problem and the user's learning level is acquired, the concept extraction unit 230 may determine at least one concept (e.g., “calculating the first term of an arithmetic progression” or “calculating the common difference of an arithmetic progression”) associated with at least one element (e.g., “arithmetic progression”, “common difference”, “positive”, and “formula”) included in the first solution explanation as a tag for the first learning problem.

Meanwhile, according to one embodiment of the invention, at least one of appropriateness of the first solution explanation, appropriateness of the at least one concept, and appropriateness of the determined tag may be verified on the basis of information inputted by at least one administrator.

Specifically, the information inputted by the at least one administrator according to one embodiment of the invention may include at least one of a predetermined learning theory, a predetermined solution explanation structure, at least one predetermined concept, and a predetermined tag.

For example, the predetermined learning theory according to one embodiment of the invention may include learning theories for various curriculums such as math theories related to identical equations or limit theorems, fundamental principles of calculus, and physics theories related to Newton's laws.

As another example, the solution explanation structure according to one embodiment of the invention may include information on formulas included in the solution explanation and positions of the formulas in the solution explanation (e.g., line numbers).

As another example, the at least one predetermined concept according to one embodiment of the invention may include names of specific units included in a textbook for a curriculum (e.g., unit names such as geometric progression, differentiation, and integration).

As another example, the predetermined tag according to one embodiment of the invention may include tags (e.g., “calculating the sum of a geometric progression”) that may be generated by combining at least one element that may be included in the solution explanation (e.g., “geometric progression”, “differentiation”, “product”, “sum”, and “calculation”). Here, according to one embodiment of the invention, the tags may be determined in order to distinguish two or more learning problems by the tags, so that the number of predetermined tags may be limited by the administrator and only a specific number (or less) of tags may exist.

As a specific example, referring to FIGS. 3A and 3B, according to one embodiment of the invention, the appropriateness of the first solution explanation may be verified on the basis of a pre-learned learning theory (e.g., a theory related to identical equations or simultaneous equations). Specifically, for example, the formula recited in the third line (i.e., the formula corresponding to (1)) and the formula recited in the fourth line (i.e., the formula corresponding to (2)) in FIG. 3B are formulas related to the same learning problem, so that the solution explanation may be determined to be appropriately generated on condition that a and r are determined as specific values when the two formulas are combined. Therefore, according to one embodiment of the invention, the appropriateness of the first solution explanation may be verified by comparing two or more elements (e.g., formulas) recited in the first solution explanation on the basis of the pre-learned learning theory.

As another example, it may be assumed that the solution explanation generation unit 220 according to one embodiment of the invention determines at least one concept (e.g., “calculating the common ratio of an arithmetic progression”) as a tag for the first learning problem. Here, according to one embodiment of the invention, the tag for the first learning problem may be verified on the basis of predetermined tags (e.g., “calculating the common difference of an arithmetic progression” and “calculating the common ratio of a geometric progression”) inputted by the administrator (e.g., may be determined as an inappropriate tag because “arithmetic progression” and “common difference” are highly associated whereas “arithmetic progression” and “common ratio” are less associated). In this case, since the tag for the first learning problem is verified as inappropriate, the concept extraction unit 230 according to one embodiment of the invention may redetermine information on at least one other concept, rather than the information on the extracted concept, as a tag for the first learning problem.

Meanwhile, it will be apparent to those skilled in the art that the verification according to one embodiment of the invention may be performed by a model verification method such as hold-out, cross-validation, or bootstrap.

Hereinafter, the method for generating a learning problem according to one embodiment of the invention will be described in detail.

First, the information acquisition unit 210 according to one embodiment of the invention may function to acquire a first learning problem. It will be apparent to those skilled in the art that the method by which the information acquisition unit 210 according to one embodiment of the invention acquires the first learning problem is the same as those discussed above.

Next, the solution explanation generation unit 220 according to one embodiment of the invention may function to generate a first solution explanation with reference to the first learning problem using a first language model, and generate a second solution explanation with reference to the first learning problem using a second language model.

Specifically, as described above in detail in connection with the first language model, the second language model according to one embodiment of the invention may include a generative artificial intelligence model that may generate responses to at least one prompt (or input). The second language model according to one embodiment of the invention may also include a deep learning-based generative artificial intelligence model, as described above in connection with the first language model.

As will be described later, according to one embodiment of the invention, the solution explanation generation unit 220 may generate solution explanations (i.e., the first solution explanation and the second solution explanation) using different language models (i.e., the first language model and the second language model), respectively, and generate a second learning problem with reference to the generated solution explanations.

Therefore, the second language model according to one embodiment of the invention may differ from the first language model in terms of at least one of a model size, model operation method, type of training data, size of the training data, and training data operation method. For example, according to one embodiment of the invention, if the first language model is a generative artificial intelligence model based on ChatGPT, the second language model may be a generative artificial intelligence model based on Codex. As another example, according to one embodiment of the invention, both the first language model and the second language model may be generative artificial intelligence models based on ChatGPT, but they may differ in terms of the type and size of the training data.

Further, in the process of generating the first solution explanation using the first language model or generating the second solution explanation using the second language model, the solution explanation generation unit 220 may generate the first solution explanation or the second solution explanation with reference to at least one of the clue associated with the first learning problem and the user's learning level, as described above.

In addition, the solution explanation generation unit 220 according to one embodiment of the invention may further generate a third solution explanation with reference to the first learning problem using a third language model. That is, the solution explanation generation unit 220 according to one embodiment of the invention may generate the solution explanations using the three language models (i.e., the first language model, the second language model, and the third language model), respectively, so that the second learning problem may be generated with reference to the generated solution explanations as will be described later.

For example, the solution explanation generation unit 220 according to one embodiment of the invention may generate the first solution explanation with reference to the first learning problem using the first language model, generate the second solution explanation with reference to the first learning problem using the second language model, and generate the third solution explanation with reference to the first learning problem, and with further reference to at least one of the clue associated with the first learning problem and the user's learning level, using the third language model.

Next, the learning problem generation unit 240 according to one embodiment of the invention may function to generate a second learning problem with reference to at least one of the first solution explanation and the second solution explanation.

Specifically, the second learning problem according to one embodiment of the invention may include a learning problem that is not identical to the first learning problem but is intended for learning of concepts identical or analogous to those of the first learning problem. For example, tags of the second learning problem according to one embodiment of the invention may be identical or analogous to those of the first learning problem. As another example, at least one element (e.g., at least one of text elements, graphic elements, and formula elements) of the second learning problem according to one embodiment of the invention may be identical or analogous to that of the first learning problem.

Therefore, according to one embodiment of the invention, as the learning problem generation unit 240 is able to generate the second learning problem, the user who has used the first learning problem may further use a learning problem identical or analogous to the first learning problem (i.e., the second learning problem), allowing the user to repeatedly learn concepts in which the user is weak.

Further, the second learning problem according to one embodiment of the invention may be generated by a learning problem generation model. Here, the learning problem generation model according to one embodiment of the invention may include a generative artificial intelligence model that may generate responses to at least one prompt (or input), as described above in connection with the first language model and the second language model. The learning problem generation model according to one embodiment of the invention may also include a deep learning-based generative artificial intelligence model. Moreover, the learning problem generation model according to one embodiment of the invention may be implemented as a model that is wholly or partially identical to at least one of the first language model and the second language model.

Meanwhile, according to one embodiment of the invention, referring to which of the first solution explanation and the second solution explanation the second learning problem is generated may be determined with reference to a result of the verification based on the information inputted by the at least one administrator. For example, the learning problem generation unit 240 according to one embodiment of the invention may compare the appropriateness of the first solution explanation and the second solution explanation, and generate the second learning problem with reference to the solution explanation determined to be more appropriate.

Further, the solution explanation generation unit 220 according to one embodiment of the invention may generate an analogous solution explanation with reference to at least one of the first solution explanation and the second solution explanation, and the learning problem generation unit 240 may generate the second learning problem with reference to the analogous solution explanation.

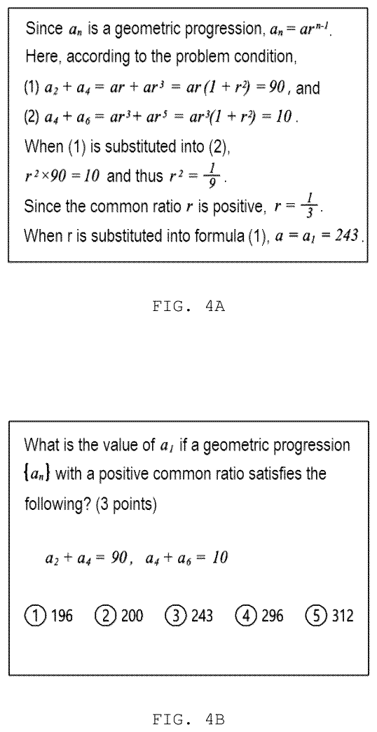

FIGS. 4A and 4B illustratively show a learning problem and a solution explanation according to one embodiment of the invention.

For example, it may be assumed that the second learning problem according to one embodiment of the invention is determined to be generated with reference to the first solution explanation among the first solution explanation and the second solution explanation. Here, referring to FIGS. 3A to 4B, the solution explanation generation unit 220 according to one embodiment of the invention may generate an analogous solution explanation (i.e., FIG. 4A) with reference to the first solution explanation (i.e., FIG. 3B), and the learning problem generation unit 240 may generate the second learning problem (i.e., FIG. 4B) with reference to the analogous solution explanation.

Continuing with the example, referring to FIGS. 3B and 4A, the solution explanation generation unit 220 according to one embodiment of the invention may generate the analogous solution explanation (i.e., FIG. 4A) by changing at least some of at least one element (e.g., the text element of the first line, the text element of the second line, the formula element of the third line, and the formula element of the fourth line) included in the first solution explanation (i.e., FIG. 3B) to other elements. As a specific example, the solution explanation generation unit 220 according to one embodiment of the invention may generate the analogous solution explanation by maintaining at least one element included in the first solution explanation and changing other elements (e.g., changing the formula elements of the third and fourth lines). Further, the analogous solution explanation according to one embodiment of the invention may be verified on the basis of information inputted by at least one administrator.

As another example, referring to FIGS. 3B and 4A, the solution explanation generation unit 220 according to one embodiment of the invention may generate an analogous solution explanation with respect to a specific position in the analogous solution explanation (e.g., the last line of a math problem solution explanation or a specific line of a solution explanation in which a specific constant is determined to be derived). Since a solution explanation may be a logical paragraph (or sentence) where a specific answer (or conclusion) is derived, the possibility of errors in the solution explanation may be reduced by generating an analogous solution explanation with respect to a specific position according to the invention.

Further, the learning problem generation unit 240 according to one embodiment of the invention may generate the second learning problem with reference to the analogous solution explanation.

For example, in the process of generating the second learning problem with reference to the second solution explanation, g problem generation unit 240 according to one embodiment of the invention may generate the second learning problem with further reference to the first learning problem. Since the second learning problem is generated in order to generate a learning problem whose concept is identical or analogous to that of the first learning problem, the second learning problem may be appropriately generated with further reference to the first learning problem according to the invention.

As another example, the learning problem generation unit 240 according to one embodiment of the invention may generate the second learning problem with reference to the analogous solution explanation, on the basis of an association between at least one of the first solution explanation and the second solution explanation and the first learning problem (e.g., an association indicating that a specific text or number in the first solution explanation is placed in a specific paragraph or position in the first learning problem).

As a specific example, referring to FIGS. 3A to 4B, on the basis of an association indicating that two formula elements shown in the first learning problem (i.e., FIG. 3A) are associated with formula elements denoted as (1) and (2) included in the first solution explanation (i.e., FIG. 3B), the learning problem generation unit 240 according to one embodiment of the invention may generate the second learning problem by referring to the formula elements denoted as (1) and (2) in the analogous solution explanation and changing the formula elements of the first learning problem. Therefore, referring to FIGS. 3A and 4B, the first learning problem (i.e., FIG. 3A) and the second learning problem (i.e., FIG. 4B) according to one embodiment of the invention may have a specific formula changed but may be related to the same concept. Here, the tags of the first learning problem and the second learning problem according to one embodiment of the invention may be the same (e.g., “calculating the common ratio of a geometric progression”).

Further, the learning problem generation unit 240 according to one embodiment of the invention may determine one of a first analogous learning problem generated with reference to the first solution explanation using the first language model and a second analogous learning problem generated with reference to the second solution explanation using the second language model as the second learning problem.

Specifically, the learning problem generation unit 240 according to one embodiment of the invention may generate a first analogous learning problem with reference to the first solution explanation using the first language model, and generate a second analogous learning problem with reference to the second solution explanation using the second language model, and may determine one of the first analogous learning problem and the second analogous learning problem as the second learning problem, with reference to appropriateness of the first analogous learning problem and appropriateness of the second analogous learning problem. As will be described later, at least one of the appropriateness of the first analogous learning problem and the appropriateness of the second analogous learning problem may be determined on the basis of information inputted by at least one administrator.

For example, the learning problem generation unit 240 according to one embodiment of the invention may determine the appropriateness of the first analogous learning problem on the basis of an association between two or more elements (e.g., formula elements or text elements) included in the first analogous learning problem, and determine the appropriateness of the second analogous learning problem on the basis of an association between two or more elements included in the second analogous learning problem.

As a specific example, when two or more formula elements included in the first analogous learning problem are determined to have one solution, the learning problem generation unit 240 according to one embodiment of the invention may determine that the two or more formula elements are highly associated, and determine that the appropriateness of the first analogous learning problem is high.

As another specific example, when two or more text elements (e.g., “strength of force” and “Newton (N)”) included in the second analogous learning problem are recognized at or above a predetermined frequency within a certain word distance (i.e., a distance or interval between a specific word and another word within a sentence) in a textbook for the same subject in a curriculum, the learning problem generation unit 240 according to one embodiment of the invention may determine that the appropriateness of the second analogous learning problem is high.

As another specific example, when the first analogous learning problem according to one embodiment of the invention includes two or more elements (e.g., “geometric progression” and “common ratio”) and the second analogous learning problem includes two or more elements (e.g., “arithmetic progression” and “common ratio”), the first analogous learning problem in which the two or more elements are more highly associated may be determined as the second learning problem.

However, it should be noted that the method of determining the second learning problem from among the first analogous learning problem and the second analogous learning problem is not limited to those described above, but may be diversely changed as long as the objects of the invention may be achieved.

As another example, in the process of generating the first analogous learning problem and the second analogous learning problem, the solution explanation generation unit 220 according to one embodiment of the invention may generate a first analogous solution explanation with reference to the first solution explanation using the first language model, and generate a second analogous solution explanation with reference to the second solution explanation using the second language model. Here, the learning problem generation unit 240 according to one embodiment of the invention may generate the first analogous learning problem with reference to the first analogous solution explanation, and generate the second analogous learning problem with reference to the second analogous solution explanation.

In other words, according to one embodiment of the invention, by using the two language models (i.e., the first language model and the second language model), solution explanations for the first learning problem are respectively generated, analogous solution explanations are respectively generated with reference to the generated solution explanations, analogous learning problems are respectively generated with reference to the two generated analogous solution explanations, and one of the two analogous learning problems (i.e., the first analogous learning problem and the second analogous learning problem) may be determined as the second learning problem. Here, according to one embodiment of the invention, at least one of the first solution explanation, the second solution explanation, the first analogous solution explanation, the second analogous solution explanation, the first analogous learning problem, and the second analogous learning problem may be verified on the basis of information inputted by an administrator (e.g., information on an association between at least one predetermined element).

Therefore, according to the invention, the second learning problem may be determined by generating the first analogous learning problem and the second analogous learning problem respectively using the different language models (i.e., the first language model and the second language model) and then comparing them, so that the appropriateness of the second learning problem (e.g., another problem related to a concept identical or analogous to that of the first learning problem) may be guaranteed.

Further, the learning problem generation unit 240 according to one embodiment of the invention may generate the second learning problem to have a difficulty level higher than a predetermined difficulty level in response to the user's learning level being not lower than a predetermined learning level, and to have a difficulty level lower than the predetermined difficulty level in response to the user's learning level being lower than the predetermined learning level.

For example, the information acquisition unit 210 according to one embodiment of the invention may acquire the user's learning level and the learning problem generation unit 240 according to one embodiment of the invention may generate the second learning problem with further reference to the user's learning level. Here, it will be apparent to those skilled in the art that the specific method by which the information acquisition unit 210 according to one embodiment of the invention acquires the user's learning level is the same as those described above.

Academic levels of two or more users (e.g., students) may vary and second learning problems with difficulty levels customized according to the academic levels of the users may be generated according to the invention. However, the academic levels of the users may be greatly diverse so that if individual second learning problems are generated according to the academic levels of all the users, the accuracy of the generated second learning problems may not be guaranteed.

Therefore, the learning problem generation unit 240 according to one embodiment of the invention may classify a learning level of a specific user (e.g., a learning level indicating that the user's academic achievement is higher or lower than the academic achievement of a group to which the user belongs) into one of two or more reference learning levels (e.g., a first reference learning level indicating that the academic achievement is determined to be high, a second reference learning level indicating that the academic achievement is determined to be low, and a third reference learning level indicating that the academic achievement is determined to be near average), and generate the second learning problem with reference to the reference learning level corresponding to the user's learning level. Here, the learning problem generation unit 240 according to one embodiment of the invention may generate the first analogous learning problem and the second analogous learning problem with reference to the reference learning level corresponding to the user's learning level, and determine one of the first analogous learning problem and the second analogous learning problem as the second learning problem.

In other words, the learning problem generation unit 240 according to one embodiment of the invention may classify diverse learning levels of two or more users into two or more reference learning levels, and generate the second learning problem (or the first analogous learning problem and the second analogous learning problem) to have difficulty levels corresponding to the reference learning levels, such that the second learning problem may correspond to diverse difficulty levels (e.g., the number of generated second learning problems (or first analogous learning problems and second analogous learning problems) may correspond to the number of reference learning levels) while being contextually consistent (or accurate). However, it will be apparent to those skilled in the art that the method of generating the second learning problem with reference to the user's learning level according to one embodiment of the invention is not limited to those described above, but may be diversely changed as long as the objects of the invention may be achieved.

Meanwhile, at least one of the first solution explanation, the second solution explanation, the first analogous solution explanation, the second analogous solution explanation, the first analogous learning problem, and the second analogous learning problem according to one embodiment of the invention may be verified on the basis of information inputted by at least one administrator.

For example, the information inputted by the at least one administrator according to one embodiment of the invention may include at least one of a predetermined learning theory, a predetermined solution explanation structure, at least one predetermined concept, and a predetermined tag. Here, the detailed descriptions of the predetermined learning theory, the predetermined solution explanation structure, the at least one predetermined concept, and the predetermined tag according to one embodiment of the invention are the same as those presented above and thus will be omitted.

As another example, at least one of the first analogous learning problem and the second analogous learning problem according to one embodiment of the invention may be verified by determining the appropriateness of the first analogous learning problem on the basis of an association between two or more elements (e.g., formula elements or text elements) included in the first analogous learning problem, and determining the appropriateness of the second analogous learning problem on the basis of an association between two or more elements included in the second analogous learning problem, as described above. Here, the association between the two or more elements according to one embodiment of the invention may be determined by the inference model described above.

As a specific example, according to one embodiment of the invention, the associations between the two or more elements respectively included in the first analogous learning problem and the second analogous learning problem may be determined on the basis of a predetermined learning theory (e.g., a math theory related to identical equations or simultaneous equations). Here, when the two or more elements are highly associated (e.g., “geometric progression” and “common ratio” may be determined to be highly associated whereas “arithmetic progression” and “common difference” may be determined to be less associated), the corresponding analogous learning problem may be verified to have high appropriateness.

However, the method of verifying the first analogous learning problem and the second analogous learning problem may be diversely changed as long as the objects of the invention may be achieved. For example, according to one embodiment of the invention, when two or more formula elements included in the first analogous learning problem are determined to have one solution, the two or more formula elements may be determined to be highly associated, and the appropriateness of the first analogous learning problem may be determined to be high, so that the first analogous learning problem may be verified to have high appropriateness.

Further, the learning problem generation unit 240 according to one embodiment of the invention may refer to a result of the verification in determining referring to which of the first solution explanation and the second solution explanation the second learning problem is generated, or in determining one of the first analogous learning problem and the second analogous learning problem as the second learning problem.

For example, the learning problem generation unit 240 according to one embodiment of the invention may compare the appropriateness of the first solution explanation and the second solution explanation, and determine referring to which of the solution explanations the second learning problem is generated, with reference to a result of the comparison.

As another example, the learning problem generation unit 240 according to one embodiment of the invention may compare the appropriateness of the first analogous learning problem and the second analogous learning problem, and determine one of the analogous learning problems as the second learning problem, with reference to a result of the comparison.

Here, the appropriateness of the solution explanation or the appropriateness of the learning problem according to one embodiment of the invention may be determined as described above, or may be determined (or verified) on the basis of information inputted by at least one administrator.

Therefore, according to the invention, the second learning problem may be generated by generating solution explanations, analogous solution explanations, or analogous learning problems respectively using the different language models (i.e., the first language model and the second language model) and comparing the generated solution explanations, analogous solution explanations, or analogous learning problems, so that the appropriateness of the generated second learning problem may be guaranteed (e.g., a high-quality learning problem may be generated).

Next, the communication unit 250 according to one embodiment of the invention may function to enable data transmission/reception from/to the information acquisition unit 210, the solution explanation generation unit 220, the concept extraction unit 230, and the learning problem generation unit 240.

Lastly, the control unit 260 according to one embodiment of the invention may function to control data flow among the information acquisition unit 210, the solution explanation generation unit 220, the concept extraction unit 230, the learning problem generation unit 240, and the communication unit 250. That is, the control unit 260 according to one embodiment of the invention may control data flow into/out of the information generation system 200 or data flow among the respective components of the information generation system 200, such that the information acquisition unit 210, the solution explanation generation unit 220, the concept extraction unit 230, the learning problem generation unit 240, and the communication unit 250 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network
200: information generation system
210: information acquisition unit
220: solution explanation generation unit
230: concept extraction unit
240: learning problem generation unit
250: communication unit
260: control unit
300: device

What is claimed is:

1. A method for generating learning problems, the method comprising the steps of:
acquiring a first learning problem;
generating a first solution explanation with reference to the first learning problem using a first language model, and generating a second solution explanation with reference to the first learning problem using a second language model; and
generating a second learning problem with reference to at least one of the first solution explanation and the second solution explanation.

2. The method of claim 1, wherein in the solution explanation generation step, an analogous solution explanation is generated with reference to at least one of the first solution explanation and the second solution explanation, and
wherein in the learning problem generation step, the second learning problem is generated with reference to the analogous solution explanation.

3. The method of claim 1, wherein in the learning problem generation step, one of a first analogous learning problem generated with reference to the first solution explanation using the first language model and a second analogous learning problem generated with reference to the second solution explanation using the second language model is determined as the second learning problem.

4. The method of claim 3, wherein in the solution explanation generation step, a first analogous solution explanation is generated with reference to the first solution explanation using the first language model, and a second analogous solution explanation is generated with reference to the second solution explanation using the second language model, and
wherein in the learning problem generation step, the first analogous learning problem is generated with reference to the first analogous solution explanation, and the second analogous learning problem is generated with reference to the second analogous solution explanation.

5. The method of claim 1, wherein in the learning problem generation step, the second learning problem is generated to have a difficulty level higher than a predetermined difficulty level in response to a user's learning level being not lower than a predetermined learning level, and to have a difficulty level lower than the predetermined difficulty level in response to the user's learning level being lower than the predetermined learning level.

6. The method of claim 4, wherein at least one of the first solution explanation, the second solution explanation, the first analogous solution explanation, the second analogous solution explanation, the first analogous learning problem, and the second analogous learning problem is verified on the basis of information inputted by at least one administrator.

7. The method of claim 6, wherein in the learning problem generation step, referring to which of the first solution explanation and the second solution explanation the second learning problem is generated is determined with reference to a result of the verification, or one of the first analogous learning problem and the second analogous learning problem is determined as the second learning problem with reference to the result of the verification.

8. The method of claim 1, wherein the second language model differs from the first language model in terms of at least one of a model size, model operation method, type of training data, size of the training data, and training data operation method.

9. A non-transitory computer-readable recording medium having stored thereon a computer program for executing the method of claim 1.

10. A system for generating learning problems, the system comprising:
an information acquisition unit configured to acquire a first learning problem;
a solution explanation generation unit configured to generate a first solution explanation with reference to the first learning problem using a first language model, and generate a second solution explanation with reference to the first learning problem using a second language model; and
a learning problem generation unit configured to generate a second learning problem with reference to at least one of the first solution explanation and the second solution explanation.

11. The system of claim 10, wherein the solution explanation generation unit is configured to generate an analogous solution explanation with reference to at least one of the first solution explanation and the second solution explanation, and
wherein the learning problem generation unit is configured to generate the second learning problem with reference to the analogous solution explanation.

12. The system of claim 10, wherein the learning problem generation unit is configured to determine one of a first analogous learning problem generated with reference to the first solution explanation using the first language model and a second analogous learning problem generated with reference to the second solution explanation using the second language model as the second learning problem.

13. The system of claim 12, wherein the solution explanation generation unit is configured to generate a first analogous solution explanation with reference to the first solution explanation using the first language model, and generate a second analogous solution explanation with reference to the second solution explanation using the second language model, and
wherein the learning problem generation unit is configured to generate the first analogous learning problem with reference to the first analogous solution explanation, and generate the second analogous learning problem with reference to the second analogous solution explanation.

14. The system of claim 10, wherein the learning problem generation unit is configured to generate the second learning problem to have a difficulty level higher than a predetermined difficulty level in response to a user's learning level being not lower than a predetermined learning level, and to have a difficulty level lower than the predetermined difficulty level in response to the user's learning level being lower than the predetermined learning level.

15. The system of claim 13, wherein at least one of the first solution explanation, the second solution explanation, the first solution analogous explanation, the second analogous solution explanation, the first analogous learning problem, and the second analogous learning problem is verified on the basis of information inputted by at least one administrator.

16. The system of claim 15, wherein the learning problem generation unit is configured to determine referring to which of the first solution explanation and the second solution explanation the second learning problem is generated with reference to a result of the verification, or determine one of the first analogous learning problem and the second analogous learning problem as the second learning problem with reference to the result of the verification.

17. The system of claim 10, wherein the second language model differs from the first language model in terms of at least one of a model size, model operation method, type of training data, size of the training data, and training data operation method.
